(19) United States
(12) Patent Application Publication
(10) Pub. No.: US 2018/0126456 A1
(43) Pub. Date: May 10, 2018

(54) Metal-Nanostructure Composites

(71) Applicants: Kang Pyo So, Everett, MA (US); Ju Li, Weston, MA (US)

(72) Inventors: Kang Pyo So, Everett, MA (US); Ju Li, Weston, MA (US)

(21) Appl. No.: 15/699,757

(22) Filed: Sep. 8, 2017

Related U.S. Application Data
(63) Continuation of application No. PCT/US2016/021781, filed on Mar. 10, 2016.
(60) Provisional application No. 62/130,766, filed on Mar. 10, 2015.

(51) Int. Cl. B22F 3/105; C01B 32/168; C09C 1/44; C01B 32/182; C22C 21/18; C22C 21/16; C22C 21/14; C22C 26/00

(52) U.S. Cl. CPC B22F 3/105; C01B 32/168; C09C 1/44; C01B 32/182; B82Y 30/00; C22C 21/16; C22C 21/14; C22C 26/00; C01B 2202/06; C22C 21/18

(57) ABSTRACT

A metal-nanostructure composite includes a nanostructure-metal matrix composite. The nanostructure-metal matrix composite includes a host metal and nanofiller dispersed in the grains of the metal. The nanofillers can include both one-dimensional nanostructures (e.g., nano-tubes, nano-rods, nano-pillars, etc.) and two-dimensional nanostructures (e.g., graphene, nano-foam, nano-mesh, etc.) to improve the radiation resistance and mechanical properties of the host metal. A method of manufacturing the metal-nanostructure composite includes obtaining carbon nanotubes (CNTs) and encapsulating the CNTs with metal particles. The method also includes consolidating the encapsulated CNTs and forming (e.g., via extrusion) the consolidated metal/CNTs to produce the metal-nanostructure composite.

### CROSS-REFERENCES TO RELATED APPLICATIONS

This application is a continuation of International Application No. PCT/US16/21781, filed Mar. 10, 2016, entitled “Metal-Nanostructure Composites,” which in turn claims priority to and benefit of U.S. provisional application Ser. No. 62/130,766, filed Mar. 10, 2015, entitled “DISPERSION OF CARBON NANOTUBES IN METALS IMPROVES RADIATION RESISTANCE AND HELIUM RESISTANCE”; each of the aforementioned applications are hereby incorporated herein by reference in their entirety for all purposes.

### BACKGROUND

Materials with extraordinary thermo-mechanical properties and radiation resistance can benefit a wide range of applications, such as nuclear fission and fusion reactors, nuclear waste containment, nuclear batteries, and space explorations. In these applications, radiation (e.g., He ions, electrons, neutrons, X-rays, gamma rays, etc.) can induce severe damages in materials, including swelling, hardening, creep, embrittlement, and irradiation-assisted corrosion. As a result, the tolerance of radiation damage (also referred to as radiation resistance) by structural materials can play a significant role in the safety and economy of nuclear energy, as well as the lifetime of nuclear batteries, spaceships and nuclear waste containers.

Conventional materials that are currently used in nuclear reactors (e.g., as fuel cladding) include, for example, zirconium and its alloys and austenitic stainless steels (SSs). However, their radiation resistance and mechanical stability at high temperatures are still limited and further improvement via traditional alloy development can be slow and expensive.

### SUMMARY

Embodiments of the present invention include metal-nanostructure composites and the methods of making and using the metal-nanostructure composites. In one embodiment, a method includes obtaining carbon nanotubes (CNTs) and encapsulating the CNTs with metal particles. The method also includes consolidating the encapsulated CNTs and forming the consolidated metal/CNTs so as to produce metal-nanostructure composites that can have superior radiation resistance (e.g., resistance to void swelling and embrittlement) and mechanical properties (e.g., strength and ductility). The CNTs can be encapsulated into the meal particles via atomic welding techniques such that the CNTs can maintain their free-standing configuration in the metal particles without significant deformation and collapse.

In another embodiment, a material includes a nanostructure-metal matrix composite. The nanostructure-metal matrix composite includes a metal and at least one nanofiller component dispersed in the grains of the metal. The nanofiller can include both one-dimensional nanostructures (e.g., nano-tubes, nano-rods, nano-pillars, etc.) and two-dimensional nanostructures (e.g., graphene, nano-foam, nano-mesh, etc.).

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates interactions of ion beams with carbon nanotubes (CNTs) in host metals.

FIG. 2 shows a schematic of a metal-nanostructure composite including nanostructures dispersed in metal grains.

FIGS. 3A-3C illustrate a method of making metal-nanostructure composites having dispersed nanostructures.

FIGS. 4A-4C illustrate a method of atomic welding that can produce dispersed nanostructures in metal grains.

FIGS. 5A-5C are images of Al/CNTs composites acquired by optical imaging, confocal Raman microscopy, and transmission electron microscopy (TEM), respectively.

FIG. 6A shows an image of a fractured area of Al/CNTs composites manufactured according to methods shown in FIGS. 3A-3C.

FIG. 6B shows tensile testing results of Al/CNTs manufactured according to methods shown in FIGS. 3A-3C.

FIGS. 7A-7C are TEM images of Al/CNTs samples before radiation tests.

FIGS. 8A-8B show micro-structures of a control Al sample and an Al/CNTs composite, respectively, after helium ion irradiation at 3.6 DPA.

FIGS. 9A-9B show micro-structures of a control Al sample and an Al/CNTs composite, respectively, after aluminum self-ion irradiation at 72 DPA.

FIGS. 10A-10B are scanning electron microscopy (SEM) images a control Al sample and an Al/CNTs composite, respectively, after 72 DPA helium ion irradiation.

FIGS. 11A-11B are TEM images of a control Al sample and an Al/CNTs composite sample, respectively, before radiation test.

FIGS. 11C-11D are TEM images of the control Al sample and the Al/CNTs composite sample, respectively, after 72 DPA helium ion irradiation to illustrate radiation-induced cracks in metal materials.

FIGS. 12A-12B are high-resolution TEM images of a control Al sample and an Al/CNTs composite, respectively, after helium ion irradiation at 72 DPA

FIGS. 13A-13B show simulation study of the effects of carbon on the radiation resistance of Al/CNTs composites.

FIGS. 14A-14D show results of Knoop hardness test of a control Al sample (FIG. 14A and FIG. 14C) and an Al/CNTs composite sample (FIG. 14B and FIG. 14D).

FIGS. 15A-15B show indented area observation in Knoop micro-hardness test on a control Al and an Al/CNTs composite sample, respectively.

FIG. 16 shows hardness of Al/CNTs composites as a function of displacement per atom after radiation.

FIGS. 17A-17B are images of Al/CNTs after radiation to show the preservation of tubular morphologies of the CNTs after radiation.

FIGS. 18A-18B show results of Raman spectroscopy of Al/CNTs composites under different levels of radiation.

FIG. 19A is STEM high-angle annular dark-field (HAADF) image of an Al/CNTs composite after radiation.

FIG. 19B shows temperature mapping of Carbon/Al density ratio in the Al/CNTs composite.

FIG. 19C shows mapping of sp³/sp² ratios of carbon element in the Al/CNTs composite.

FIG. 19D shows the electron energy loss spectroscopy (EELS) spectrum of the carbon in an area marked in FIG. 19C.

FIG. 20 is an image of Al₄C₃ nano-rod in Al/CNTs composites after radiation.

FIGS. 21A-21B shows irradiation direction and generation of 1D Al₄C₃ nano-rods in Al/CNTs composites in response to radiation.

FIGS. 21C-21E show results of composition study of the Al₄C₃ shown in FIGS. 21A-21B.

FIGS. 22A-22B show hardness of Au/CNTs composites.

### DETAILED DESCRIPTION

Nano-structuring can be a promising approach to improve the radiation resistance of materials and address, at least partially, challenges in existing methods to develop radiation resistant materials. For example, carbon nanotubes (CNTs) are known to be mechanically robust and flexible. Without being bound by any particular theory or mode of operation, when CNTs are uniformly dispersed inside metal (also referred to as host metal) as 1D fillers, instead of only being attached to the metal surfaces, their high aspect ratio η (up to 10⁸) can create prolific internal interfaces with the metal matrix. These internal interfaces may act as venues for the radiation defects to recombine (i.e., self-heal).

In addition, based on percolation theory and geometrical simulations, a random 3D network of 1D fillers can form globally percolating transport paths even with diminishing volume fraction ϕ→0, if η→1. The global percolating transport paths can also mitigate embrittlement and swelling. As understood in the art, embrittlement and swelling can be exacerbated by Helium (alpha particle) accumulation inside materials. The globally percolating paths formed by 1D fillers can function as “nano-chimneys” that can outgas the accumulated helium and other fission gases to an external fission-product gettering and/or trapping system, thereby mitigating embrittlement and swelling.

When used in nuclear reactors or other radiative environments, it can be helpful for the metal-CNT composite (MCC) to have the following properties. First, the dispersion of CNTs does not degrade thermo-mechanical properties (strength, toughness, thermal conductivity, etc.) of the CNTs. In other words, CNTs can maintain their thermal-mechanical properties after dispersion. Second, under radiation, the dispersed CNTs can mitigate radiation embrittlement and swelling reduced (e.g., due to self-healing effect of the filler-metal interfaces) in MCC compared to a control metal without the dispersed CNTs. Third, the 1D nano-fillers themselves can also sustain heavy dose of radiation. For example, typical radiation exposure to the nuclear fuel cladding material is ˜15 DPA (displacements per atom) before they are taken out of the reactor. Core internals in commercial light-water reactors should sustain around 80 DPA after 40 years of plant operations, and advanced fast reactors would demand even more.

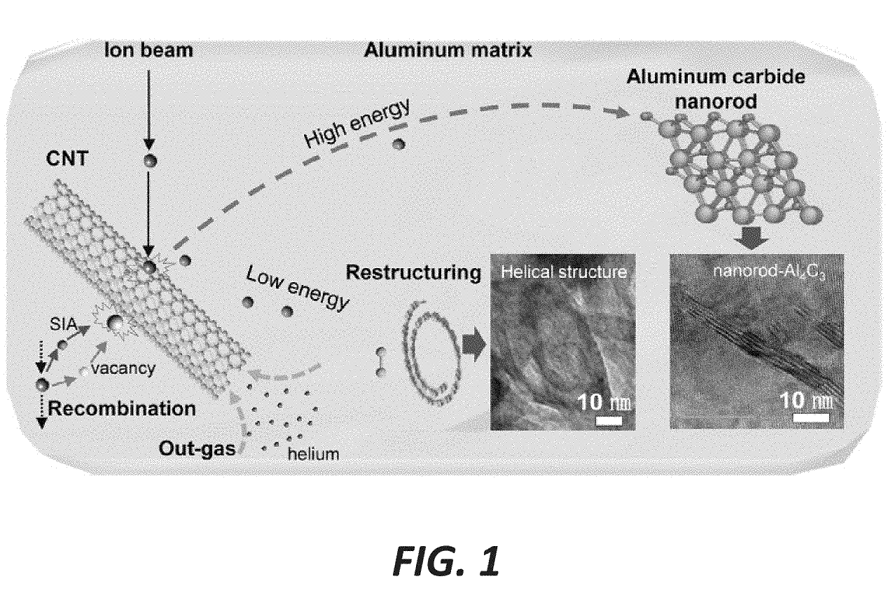

FIG. 1 shows interactions between 1D nano-fillers and incident ion radiations in Aluminum/Carbon nanotube (Al/CNT) composites to illustrate the nano-structuring approach described herein. Under ion irradiation, CNTs can undergo disintegration and then form aluminum carbide from interaction with high energy ions (top arrow) or restructure to helical CNT structure from interaction with low energy ions (bottom arrow).

The properties of Al/CNT can depend on the modification of interfaces of 1D nanostructure upon irradiation. The energies of incoming ions are usually absorbed to transform CNT structure to rearranged carbon nanostructure, or aluminum carbide nanorods, depending on the ion type and beam energy. The 1D interfaces can reduce the supersaturation of radiation-generated vacancies, by boosting recombination with self-interstitial atoms (SIA) and interstitial clusters. Lightweight ion irradiation (e.g., He ion radiation) can generally generate more “sparse” collision cascades with lower defect density and shorter length compared to heavy ions. Therefore, He ion irradiation can cause less Al/C mixing than Al ion irradiation since an interstitial Al atom can quickly find the nearest vacancy of the same chemical species. The CNT under lightweight radiation can undergo restructuring and form a helical carbon nanostructure. Irradiation with heavier Al ions, which can produce “denser” collision cascades and more Al/C mixing, can change the composition of CNT fillers by forming an aluminum carbide phase with 1D nanorod morphology. To take advantage of the above processes for improving radiation resistance, uniform dispersion of CNTs within the host metal without degradation to CNTs or Al matrix can be the very beneficial.

The nano-structuring approach described in this application employs an atomic welding technique to uniformly disperse nanofillers (including 1D and 2D nanostructures) within host metals. In atomic welding, nanofillers can be initially disposed on surfaces of multiple metal particles. These metal particles can then merge together (e.g., through Ostwald ripening), thereby encapsulating the nanofillers within the resulting merged metal. For host metals having strong tendency of oxidation, the process can be performed in a glove box to prevent oxidation. In addition, a polar covalent coating can be applied on the nanofillers to increase wettability and facilitate the atomic welding.

These methods can allow mass-production of metal/carbon nanotube (CNT) composites that have improved radiation tolerance. The produced 0.5 wt % Al+CNT composite can have improved tensile strength without reduction of tensile ductility before radiation, and reduced void/pore generation and radiation embrittlement at high displacements per atom (DPA). Under helium ion irradiation up to 72 DPA, the 1D carbon nanostructures survive, while sp² bonded graphene transforms to sp³ tetrahedral amorphous carbon. Self-ion (Al) irradiation can convert CNTs to a metastable form of Al₄C₃, which can maintain a slender configuration as 1D nano-rods, thereby preserving the prolific internal interfaces that can catalyze recombination of radiation defects and reduce radiation hardening and porosity generation. The 1D fillers may also form percolating paths of “nano-chimneys” that outgas the accumulated helium and other fission gases, addressing the gas accumulation problem.

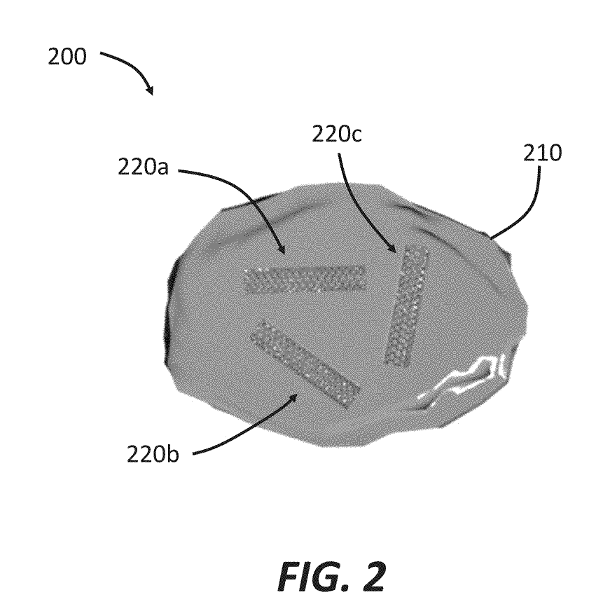

FIG. 2 shows a metal-nanostructure composite 200 that can have increased radiation resistance and improved mechanical properties, compared to the host metal alone. The composite 200 includes a plurality of nanofillers 220a, 220b, and 220c (collectively referred to as nanofillers 220) dispersed within a metal 210.

The dispersion (also referred to as distribution) of the nanofillers 220 can have several features. First, each individual nanofiller 220 substantially maintains its free-standing form within the metal 210, in a similar manner like a leave preserved in a fossil, or an insect trapped in an amber. In other words, the dispersion process does not cause deformation or collapse of the individual nanofillers 220, thereby maintaining prolific interfaces between the nanofiller 220 and the metal 210.

Second, the nanofillers 220 are distributed within the metal 210 in a substantially uniform manner. For example, the average distance between neighboring nanofillers 220 (also referred to as inter-filler distance) can be about 100 nm and the fluctuation of inter-filler distance can bout about ±50 nm. In another example, the average inter-filler distance can be about 50 nm to about 1 μm and the fluctuation of inter-filler distance can be about ±25 nm to about ±500 nm. In yet another example, the average inter-filler distance can be about 75 nm to about 200 nm and the fluctuation of inter-filler distance can be about ±35 nm to about ±100 nm.

In addition, the nanofillers 220 do not create grain boundary flocculation of the metal 210. The radiations damage such as void swelling and embrittlement usually occur from the vacancy and intestinal generation inside grain. Furthermore, the deformation of metal can also occur from dislocation movement inside grain. Nanofillers inside grain without having grain boundary flocculation can provide more chances to have interaction with vacancy, interstitial, and dislocations. This structure, therefore, can enhance the mechanical strength and radiation resistance.

The metal 210 can include various materials. In one example, the metal 210 includes aluminum (Al), which is cost-effective and very widely used. For example, Al can be used as the fuel cladding materials in research reactors, as well as containment for nuclear waste, components for robots in radiation environments, etc. Its light density may impart significant advantage for space applications. Al has low thermal neutron absorption cross-section of 0.232 barn, above only those of Mg (0.063 barn), Pb (0.171 barn) and Zr (0.184 barn) among structural metals, and high corrosion resistance in water, therefore it is already widely used in low-temperature research reactors. The development of Al/CNT may not only benefit research reactors, but also provide guidance for designing new kinds of cladding materials (e.g., Zr+=/CNT, Stainless steel/CNT) that can be used in commercial reactors. Second, Al is used in nuclear battery since it is reflective, and has low production rate of Bremsstrahlung radiation due to low atomic number. Thus it has been recommended for several components in designs of nuclear battery such as shielding, current collector, and electrode. Al+CNT will increase the lifetime of nuclear battery because of better radiation resistance. This composite may also alleviate helium accumulation from alpha decay, which is one of the main engineering issues associated with radioisotope thermoelectric generator (RTG).

In another example, the metal 210 includes gold (Au), which is highly resistant to oxidation in air and water and widely used in electronics and jewelry industry. Dispersing nanofillers 220 within gold can increase the wear resistance (e.g., resistance to scratch or other mechanical damages). In yet another example, the metal 210 includes iron, which can be useful in nuclear reactors due to its mechanical stability. In yet another example, the metal 210 can include other materials such as Magnesium (Mg), Zirconium (Zr), Copper (Cu), Silver (Ag), and Platinum (Pt), among others.

In yet another example, the metal 210 can include more than one metal element or alloys. Table 1 below shows the composition (at %) of one Al alloy that can be used to make the composite 200.

TABLE 1
An example metal alloy used for metal-nanostructure composites

| Samples | Al | Si | Mg | Fe | Cu | S | Zn | Ga | Cl | Ca | Na | Ni |
|---|---|---|---|---|---|---|---|---|---|---|---|---|
| Al | Bal- | 0.662564 | 1.031844 | 0.150923 | 1.086861 | 0.008563 | 0.067434 | 0.013915 | 0.026759 | 0.048167 | 0.078138 | 0.006422 |
| matrix | ance | | | | | | | | | | | |

The nanofillers 220 can also employ various types of nanostructures. In general, it can be helpful for the nanofillers 220 to produce abundant interfaces with the metal 210 when dispersed in the metal 210. To this end, the nanofillers 220 can have a large surface area to volume ratio. In general, a larger surface area to volume ratio is more beneficial in creating interfaces with the metal.

In one example, the nanofillers 220 include one-dimensional (1D) nanostructures such as nanotube (e.g., carbon nanotube, multiwall carbon nanotube, etc.), nano-rod, nano-pillar, nano-wire, nano-fiber, and nano-ribbon, among others. The aspect ratio of these 1D nanostructures can be greater than 100, greater than 1000, greater than 10⁴, greater than 10⁵, and even higher (e.g., about 10⁸ for carbon nanotubes made from a single-atom layer). For example, multiwall carbon nanotubes (MWCNTs) can be used as the nanofillers 220. The diameter D of the MWCNTs can be about 10 nm to about 30 nm and the length L of the MWCNTs can about 10 μm, creating an aspect ratio η˜L/D of about 300-1000.

In another example, the nanofillers 220 include two-dimensional (2D) nanostructures such as nano-sheet (e.g., single layer graphene, double-layer graphene, multilayer graphene, etc.), nano-mesh, and nano-foam, among others.

The nanostructures in the nanofillers 220 can be made of various elements. In one example, the nanofillers 220 include carbon nanostructures such as carbon nanotubes, graphene, or any other carbon nanostructure known in the art. In another example, the nanofillers 220 include other elements such as oxygen (O), silicon (Si), boron (B), and nitrogen (N). In yet another example, the nanofillers 220 can include more than one element. For example, the nanofillers 220 can include a carbon nanostructure doped with another element such as silicon, nitrogen, oxygen, and boron, among others.

The nanofillers 220 can further includes a polar covalent coating to increase the wettability of the nanofillers 220, thereby facilitating the dispersion of nanofillers 220 within the metal 210. In one example, the polar covalent coating includes silicon carbide (SiC). In another example, the polar covalent coating includes silicon oxide (SiOx). In yet another example, the polar covalent coating can include materials such as oxygen compound, boron compound, nitrogen compound, and/or carbon compound.

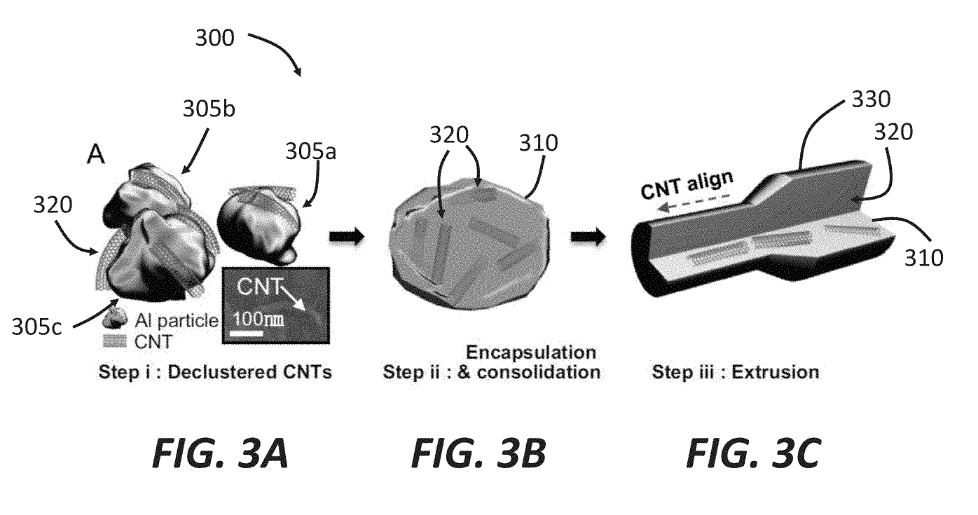

FIGS. 3A-3C illustrate a method 300 for manufacturing metal-nanostructure composites including nanofillers dispersed in host metals. The method 300 includes obtaining carbon nanotubes (CNTs) 320 as shown in FIG. 3A. At this step, bulks or clusters of nanotubes can be broken up (i.e. declustered) to acquire individual CNTs 320. The declustering can be achieved by, for example, mixing bulks of nanotubes with metal particles 305a, 305b, and 305c (collectively referred to as metal particles 305) in a mixer. The metal particles can have a diameter (or other characteristic dimensions) of about 100 nm to about 10 um. After mixing, the declustered individual CNTs 320 can be attached to the surface of metal particles 305 (see FIG. 3A). The weight ratio of nanotubes to metal powders can be about 1:20 to about 1:1000 (e.g., about 1:20, about 1:50, about 1:100, about 1:200, about 1:500, or about 1:1000). For example, one gram of multiwall carbon nanotubes (MWCNT) (e.g., CM95 manufactured by Hanwha Nanotech, Korea) can be declustered on 99 grams of Al alloy powder (composition shown in Table 1). The mixing can be carried out by a high-speed blade mixer (e.g., VM0104 manufactured by Vita-Mix, USA) for 20 minutes at about 37,000 rpm.

FIG. 3B shows that the CNTs 320 are encapsulated and consolidated within a metal 310. In one example, the metal 310 can be formed by the merge of the multiple metal particles 305 shown in FIG. 3A. In another example, the metal 310 can be formed by the merge of the multiple metal particles 305 with additional metal powders. The merge of metal particles can be achieved by, for example, a planetary ball miller. Encapsulation can be helpful in protecting the CNTs 320 from being damages as a result of mechanical pulverization during further dispersion.

In some examples, the encapsulation process can be performed in a glove box (e.g., manufactured by M.O. Tech, Korea) to prevent oxidation. The glove box can create an inert atmosphere, which includes a gaseous mixture that contains little or no oxygen and primarily consists of non-reactive gases or gases that have a high threshold before they react. Example non-reactive gases include nitrogen, argon, helium, carbon dioxide, or any other non-reactive gas known in the art. The oxygen and moisture level can be set at, for example, below 1 ppm.

The encapsulated CNTs 320 and metal 310 can be consolidated to create Al—C covalent bonds. The consolidation can be carried out by a spark plasma sintering process, also referred to as field assisted sintering technique (FAST) or pulsed electric current sintering (PECS). In one example, the spark plasma sintering (e.g., SPS, 50 t, 50 kW, Eltek, Korea) can be performed, for example, under a pressure 40 MPa at 560° C. for 15 min.

FIG. 3C shows that the consolidated Al/CNT composite is formed by, for example, an extrusion process. The composite obtained at steps shown in FIG. 3B can be forced through an extrusion machine 330 so as to produce Al/CNT composite of desired form factors. In one example, the bulk Al/CNT composites are extruded to 2.5 mm in diameter with an extrusion ratio of 9:1 at a temperature of about 550° C.

The method 300 shown in FIGS. 3A-3C can further include creating a polar covalent coating on the CNTs 320 to improve the bonding between the CNTs 320 and the metal 310. In one example, silicon (e.g., silicon nanoparticles) and carbon material (e.g., nanotubes) can be mixed together. Then an induction heating step can be performed to selectively increase the temperature of the nanotubes due to the mobility of electrons within nanotubes in response to magnetic field created by induction. The heating can create thermal decomposition of carbon nanotubes and bonding with silicon to produce Si—C covalent bond. More details of forming Si—C covalent bond can be found in U.S. Patent Publication No. 20120210823 A1, which is incorporated herein by reference in its entirety for all purposes. In another example, other covalent coating materials can be used, such as silicon compound, oxygen compound, boron compound, nitrogen compound, and carbon compound, among others.

The method 300 uses aluminum as the host metal and carbon nanotubes as the nanofillers for illustrating purposes. In practice, the method 300 can be adapted to manufacture other metal-nanostructure composites as described in previous sections.

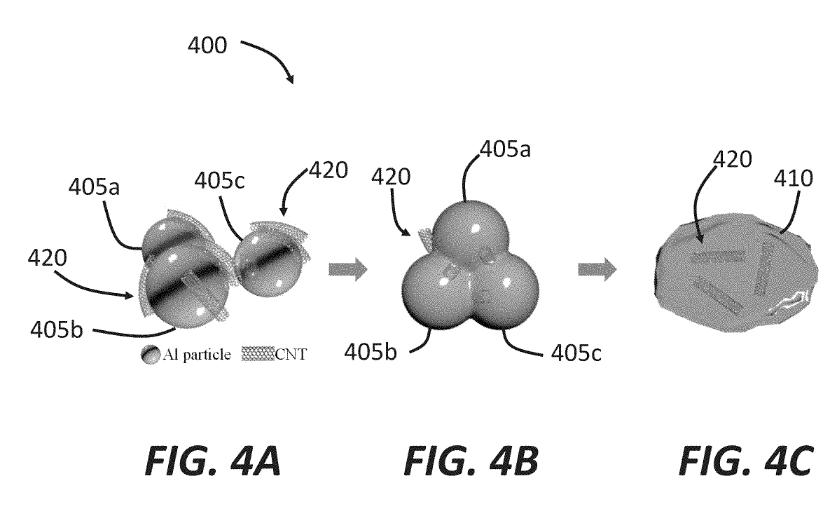

FIGS. 4A-4C illustrate an atomic welding method that can be employed to encapsulate and consolidate nanofillers within metals. The method 400 shown in FIGS. 4A-4C use CNTs as the nanofillers and Al as the host metal for illustrating and non-limiting purposes only. The method includes declustering CNTs 420 by mixing bulk nanotubes with Al powders. The declustered CNTs 420 are usually bonded to the surface of Al particles 405a to 405c (collectively referred to as Al particles 405). FIG. 4B shows that the surface diffusion of the Al particles 405 can drive the Al particles 405 to merge together with each other (or with additional metal particles). In one example, the additional metal particles can also be Al particles. In another example, the additional metal particles can include other metal materials (also referred to as brazing). The merge can encapsulate the CNTs 420 within a monolithic metal 410 as shown in FIG. 4C.

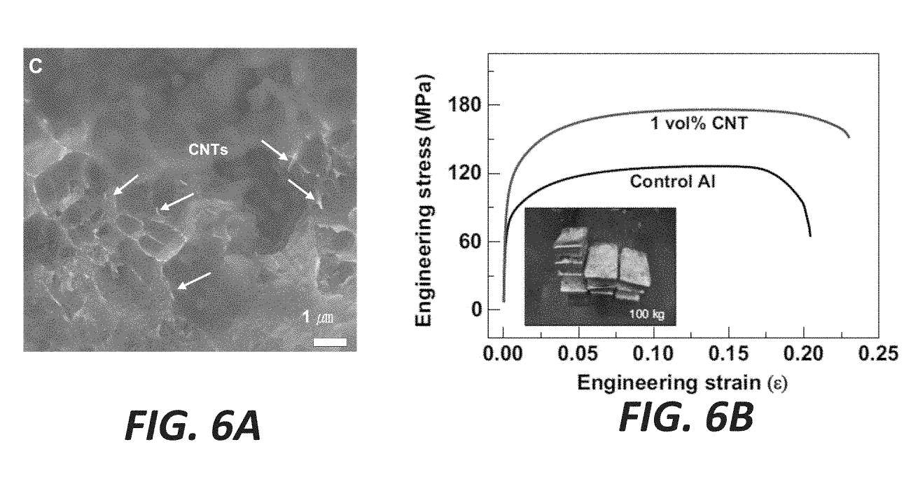

The methods 300 and 400 illustrated in FIGS. 3A-3C and FIGS. 4A-4C, respectively, are industrially scalable. Al/CNT nano composites weighing more than 100 kg can be readily produced (e.g., see FIG. 6B (inset)). Cost analysis also indicates that the specific weight cost (including raw material cost of nanotubes and aluminum and processing costs) can be less than two times the price of bulk-scale Al alloy.

Characterization of Metal-Nanostructure Composites

This section describes characterizations of example metal-nanostructure composites, such as Al/CNT composites, using a high-energy ion accelerator to inject He and Al ions that can generate atomic displacements in the composites, in lieu of neutrons. The CNTs dispersed in Al can maintain their thermo-mechanical properties and mitigate embrittlement and swelling problems in the resulting Al/CNT composite. In addition, the 1D form factor of nano-fillers can also sustain 72 DPA of He ion irradiation and 72 DPA of Al self-ion radiations at room temperature. These experimental results are unexpected and surprising because every carbon and aluminum atoms are knocked out about 102 times under the radiation level, yet the 1D nano-morphologies are preserved, along with the prolific internal interfaces. The morphological robustness of 1D nano-fillers in non-equilibrium conditions can be reminiscent of nanowire growth in chemical vapor deposition that violates equilibrium Wulff construction. The accelerator-based ion irradiation tests can be performed at room temperature (homologous temperature T/TM=0.32, Al's melting point is TM=933.47 K). At this range, volumetric swelling from void formation can be prominent when radiation exposure is larger than 10 DPA, and thereby allowing convenient study of radiation resistance.

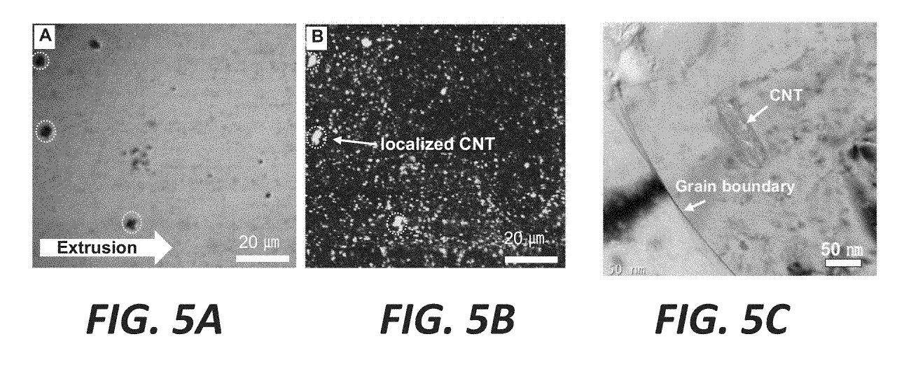

FIGS. 5A-5C show morphologies of CNTs in Al/CNTs composites manufactured according to methods described in this application. More specifically, FIG. 5A is an optical image of Al/CNTs composite after extrusion. FIG. B is a G-mode mapping from confocal Raman microscopy of the Al/CNTs composites. FIG. 5C is a transmission electron microscopy (TEM) image of the Al/CNTs composite.

These images show that CNTs are embedded inside the Al grain (e.g., as indicated by the white arrow in FIG. 5C). These observations are the evidence that CNTs can be highly dispersed after the processing, thereby preserving the large surface area (now interface area with the surrounding metal) and improving radiation resistance as introduce above.

FIG. 6A is an SEM image of a fractured area in an Al/CNTs composite after tensile test in which CNTs have a volume ratio of about 2%. As indicated by the white arrows, multiwall CNT strands are protruding out of the fractured area. This fiber pull-out between CNTs and Al can induce load transfer and improves fracture toughness.

FIG. 6B shows experimental results of ASTM E8 standard tensile testing using a bulk specimen of the Al/CNTs composite after hot extrusion. The inset in FIG. 6B is an image of about 100 kilograms of the specimen used for the testing. The large quantity also demonstrates that the methods described herein allow mass production of Al/CNTs composites for large scale industry uses. Testing results of a control Al sample is also included in FIG. 6B to show the improvement of mechanical strength induced by the dispersed CNTs. As seen from the typical stress-strain curves in FIG. 6B, the tensile strength can be enhanced by about 34% at 1 vol % MWCNTs (ϕ=0.01), without sacrificing tensile ductility.

Ion radiation tests are also performed on Al/CNTs composites to show improved radiation resistance of these composites. More specifically, extruded 2.5 mm of control Al and Al/CNTs wire (e.g., see FIG. 3C) are irradiated at the room temperature using helium ions and aluminum ions. For helium ion irradiation, the total influences of irradiation are 1×10¹⁷, 5×10¹⁷ and 2×10¹⁸ ions/cm² at a constant beam current of 400 nA, 5 μA and 5 μA, respectively, under the 100 keV of acceleration voltage. For aluminum self-ion irradiation, the total particle fluence are about 1×10¹⁷, 3.75×10¹⁶ and 1.5×10¹⁷ ions/cm² under the 2 MeV of acceleration voltage. These irradiation conditions can correspond to 3.6, 16 and 72 displace per atom (DPA) at maximum point. The experimental parameters are summarized in Table 2 below.

TABLE 2
Experimental conditions of ion radiation tests

| Ion | | Max. | | | Beam | |
|---|---|---|---|---|---|---|
| species | Samples | DPA | Energy | | current | Dose |
| He⁺ | Control Al/ | 3.6 | 100 | keV | 400 nA | 1E17 cm⁻² |
| | Al + CNTs | 16 | 100 | keV | 5 uA | 5E17 cm⁻² |
| | 1 vol % | 72 | 100 | keV | 5 uA | 2E18 cm⁻² |
| Ar+ | Control Al/ | 3.6 | 2 | MeV | 200 nA | 7.5E15 cm⁻² |
| | Al + CNTs | 16 | 2 | MeV | 200 nA | 3.75E16 cm⁻² |
| | 1 vol % | 72 | 2 | MeV | 200 nA | 1.5E17 cm⁻² |

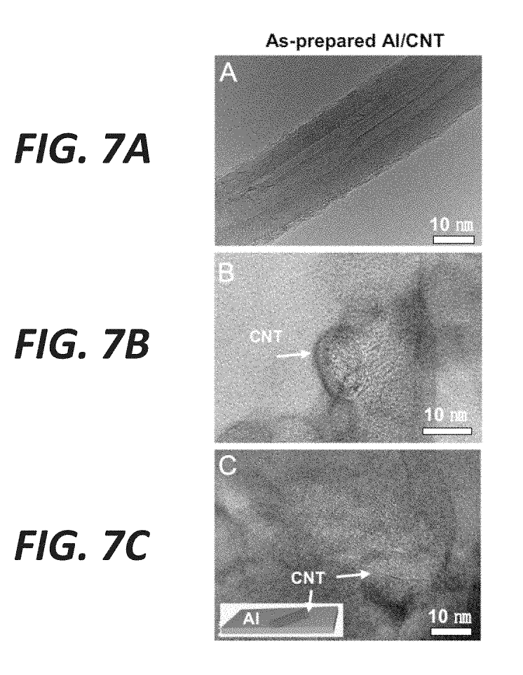

FIGS. 7A-7C are TEM images of Al/CNTs composites before radiation test to show the dimensions of the CNTs. The diameter of the inner space and the wall thickness of the MWCNT are 10 nm and 7-10 nm, respectively, as indicated in the TEM image in FIG. 7A. The initial geometry resembles a “nano-chimney”. The walls of the graphene constituting the CNTs are clearly visible in the TEM images shown in FIG. 7B and FIG. 7C, indicating that there is no significant chemical mixing the CNTs.

Without being bound by any particular theory or mode of operation, if the CNTs are entirely straight and randomly distributed, then analytical modeling and Monte Carlo simulations gives percolation threshold estimate:

$${φ}_{c} \approx \frac{1}{2 \frac{L}{D} + 3 + π + \frac{π D}{2 L}} \qquad ( 1 )$$

which for an aspect ratio η˜L/D=300, gives ϕ_{c}=0.0016, and for η˜L/D=1000, gives ϕ_{c}=5×10⁻⁴. The CNT volume fraction as used in samples here is an order of magnitude larger than φ_{c}. Therefore, the CNTs can form a globally percolating network of nano-chimneys. Any helium gas is expected to travel facilely in 1D hollow structure like CNTs with smooth interior walls.

To test the radiation tolerance of the Al/CNT composites, the samples are irradiated by 100 keV helium ions and 2 MeV aluminum self-ion up to 3.6, 16 and 72 DPA, respectively. The results are compared with the pure Al control samples under the same irradiation conditions.

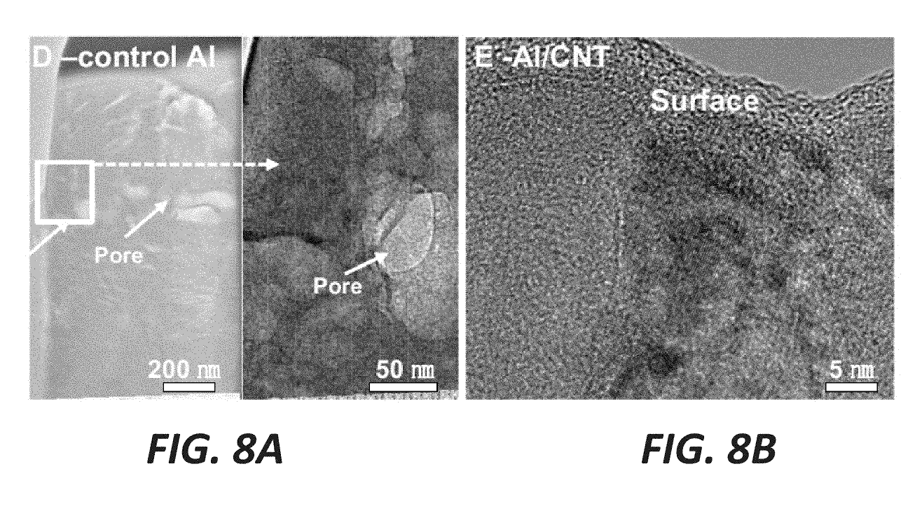

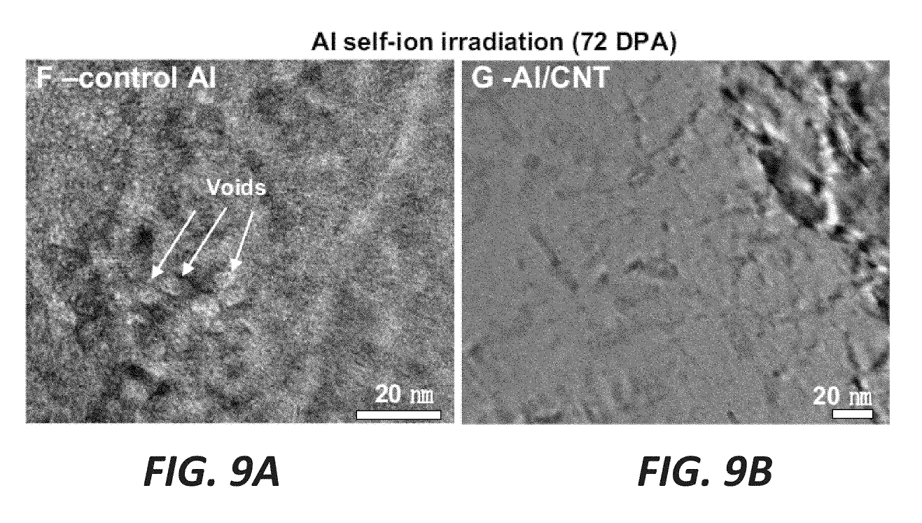

FIGS. 8A-8B show micro-structures of a control Al sample and an Al/CNTs composite, respectively, after helium ion irradiation at 3.6 DPA. FIGS. 9A-9B show micro-structures of a control Al sample and an Al/CNTs composite, respectively, after aluminum self-ion irradiation at 72 DPA. In general, the irradiation can generate nano-cavities within metals by the aggregation of radiation-induced vacancies. The positive He gas pressure, under He ion radiation, can further stabilize the larger cavities compared to Al-ion irradiation. Bubbles appear at just 3.6 DPA in pure Alf or He-ion irradiation. The formation of large cavities with diameters ranging 100-200 nm can be observed in the control Al (FIG. 8A, left). The higher magnification indicates that small cavities are also generated (FIG. 8A, right). In contrast, the Al+CNT 1 vol % sample has no cavity generation at the same DPA (FIG. 8B). The higher magnification provides clear evidence of no bubble/void generation at a 3.6 DPA He-ion irradiation level in Al/CNT composites. Under even stronger radiation, no cavity is observed after 72 DPA Al self-ion irradiation of the Al+CNT (FIG. 9B). CNTs dispersed inside Al grain can suppress cavity generation completely up to at least 3.6 DPA for He-ion and 72 DPA for Al self-ion radiation.

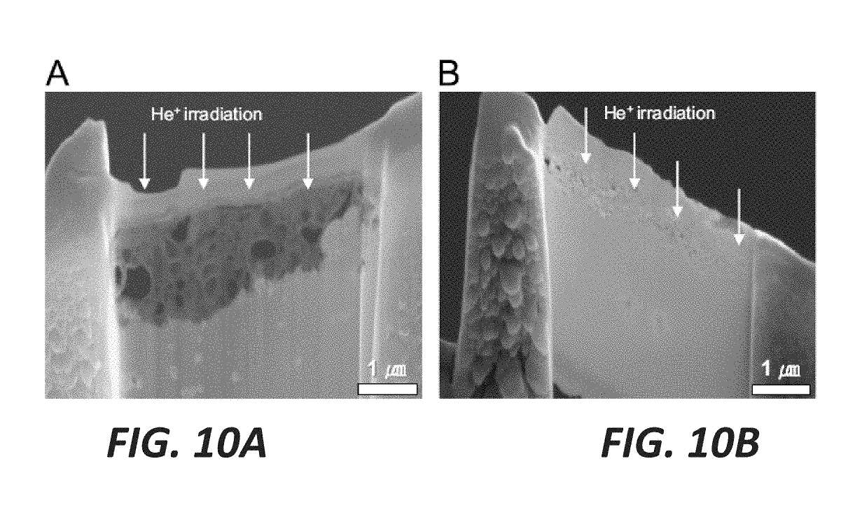

FIGS. 10A-10B are scanning electron microscopy (SEM) images a highly porous control Al and an Al/CNT (1 vol %) composite, respectively, after 72 DPA helium ion irradiation. Cavities of various sizes are observed in the control Al sample as shown in FIG. 10A. Cavities are also generated in the Al/CNT composite sample, but the sizes are much smaller as seen in FIG. 10B. The largest cavity in Al/CNT composite is about 170 nm in diameter and is about 20 times smaller in volume compared to the pores in the control Al. Therefore, the incorporation of CNTs in Al can suppress porosity development in severe radiation damage conditions.

The noticeable reduction of porosity in Al/CNTs composites also implies that He gas can readily diffuse out of Al matrix. Two mechanisms are possibly. First, Helium gas can diffuse out along the CNT-metal interface. Second, the interspace and central hollow space inside CNTs can act as pathways (e.g., “nano-chimneys”) for He gas to transport out of the metal. Since the mechanical strength is enhanced significantly by load transfer associated with strong anchoring of Al onto the CNT surface, it is more likely that the second mechanism is responsible for the helium gas diffusion.

The microstructure of the helium ion irradiated samples can be further characterized by high-resolution TEM (e.g., HRTEM, 200 keV, 2010F, manufactured by JEOL). The TEM sample can be prepared using focused ion beam (e.g., FIB, Helios Nanolab 6000, FEI) with a Ga ion milling process and a Pt protection layer. The sample can be cut from the surface because helium ion penetration depth is usually less than 1 um. The cavities in all the samples can be determined by under/over focusing under TEM. The sizes and cavities can be characterized by measuring diameter of all the cavities according to the depth. The average diameters of cavities versus depth can be calculated by area-weighted average diameter:

$${d}_{av} = \frac{{\sum }_{i}^{n} d ( i ) A ( i )}{{\sum }_{i}^{n} A ( i )} \qquad ( 2 )$$

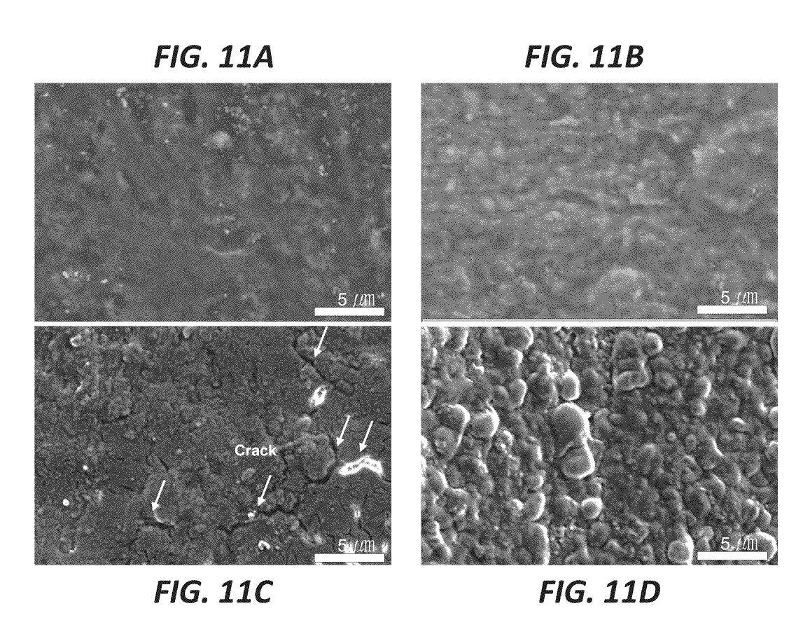

FIGS. 11A-11B are TEM images of a control Al sample and an Al/CNTs composite sample, respectively, before radiation test. FIGS. 11C-11D are TEM images of the control Al sample and the Al/CNTs composite sample, respectively, after 72 DPA helium ion irradiation. Cracks of various sizes and shapes are observed in the control Al sample after radiation as indicated by white arrows in FIG. 11C. The cracks can be generated from the volume expansion of cavities after the irradiation. In contrast, no visible crack is observed in the Al/CNTs composite sample in FIG. 11D.

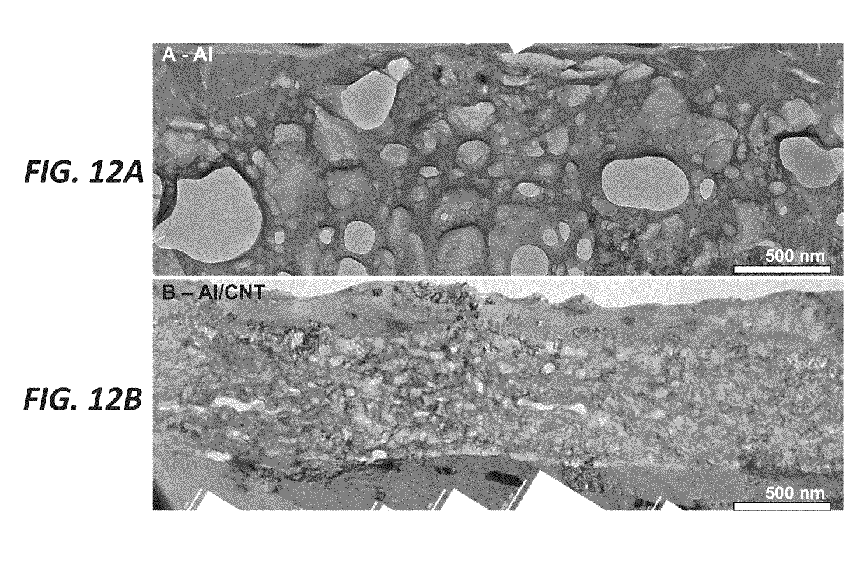

FIGS. 12A-12B are high-resolution TEM images of a control Al sample and an Al/CNTs composite, respectively, after helium ion irradiation at 72 DPA. Bubbles (or cavities) of various sizes and shapes observed throughout the entire sampled area in the control Al sample as seen in FIG. 12A. In contrast, cavities generated in the Al/CNTs composite are much smaller and much less visible.

To quantify the effects of CNTs on the radiation damage induced by He ion irradiation in the Al, the stopping and range of ions in matter (e.g., SRIM-2013) simulation (see, e.g., srim.org) can be performed with and without carbon element in the Al matrix. The carbon content of Al+1 vol % CNT can be roughly 0.5 wt %. In the simulation, carbon atoms can be uniformly dispersed in the Al matrix to extract the effect of the carbon atoms alone. The maximum DPA is predicted to occur at 534 nm in depth, slightly shallower than the maximum peak (596 nm) of injected He ion.

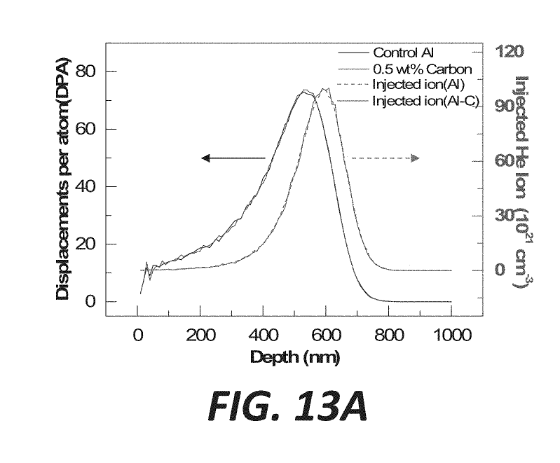

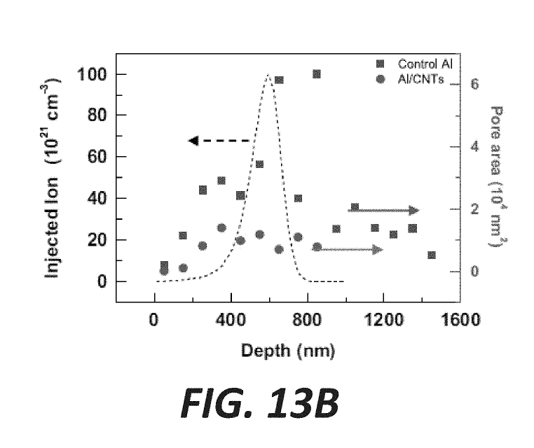

FIG. 13A shows the depth profile of radiation damage in unit of displacements per atom (DPA) and injected helium ion obtained from SRIM simulation. Almost exactly the same profiles of injected ion and DPA profiles are observed in FIG. 13A, regardless of 0.5 wt % carbon addition. Therefore, the 0.5 wt % carbon alone in Al does not make noticeable influence on the helium injection and DPA profiles. In other words, the control Al samples and the Al/CNTs composite samples are under the same radiation conditions, further verifying that the different performances in radiation resistance are a result of improved gas diffusion due to CNTs and the recombination of the interstitials and vacancies at the CNT interface.

FIG. 13B shows injected ion (SRIM) and pore areas versus depth, for 100 keV He ion injection to 72 DPA peak damage. The simulated damage profiles agree well with the experimentally observed porosity generation profile. However, the absolute cavity area and the size are significantly smaller in the Al/CNT composites than that in the control sample, likely due to the fact that CNTs provide large internal interface area.

If the CNTs are randomly dispersed, the furthest distance between any point of its nearest CNTs can scale as L_{furthest} ∝Dϕ^{-1/2} (D=diameter). For 1 vol % MWCNT sample, L_{furthest} is around 200 nm, which is still an order of magnitude longer than the typical size of a radiation cascade, which is about 10-20 nm. Therefore, the improvement in porosity suggests that porosity development involves length scales quite beyond a single cascade annealing. For comparison, ultra-fine grained austenitic stainless steel with a grain size of 100 nm can exhibit 5 times slower void swelling rate up to 80 DPA, and L_{furthest} in that case is 50 nm if all the grain boundaries (GB) are effective venues for recombination. Compared to that system of “2D nano-engineered” network of GBs, the “1D nano-engineered” CNTs/Al composite described herein has 4 times longer L_{furthest} and 15 times less interfacial area per volume. Yet the composite can achieve similar performance in cavity suppression.

The surface mechanical properties of Al/CNTs composites can be characterized by Knoop hardness (e.g., LM 248 AT, LECO, USA). The test can be carried out under a 10 g force for 10 seconds to study the response of sample surface to the force.

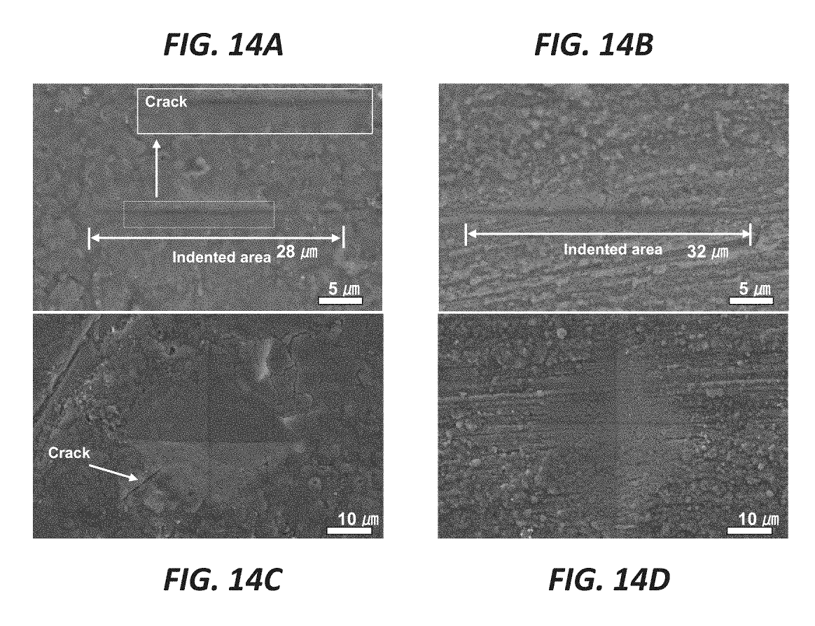

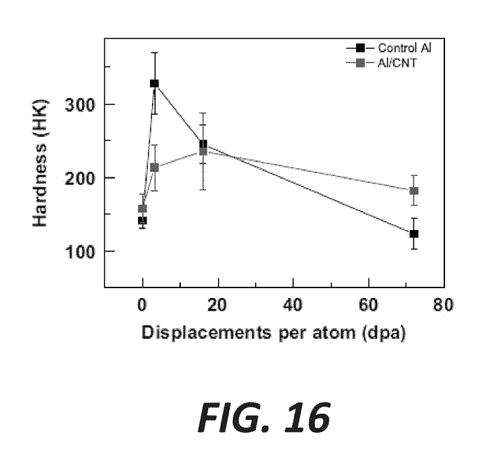

FIG. 14A-14D show results of Knoop hardness test of a control Al sample (FIG. 14A and FIG. 14C) and an Al/CNTs composite sample (FIG. 14B and FIG. 14D). In FIGS. 14A-14B, indented area of the control Al and the Al/CNTs composite are shown. The line shape dimple of the Knoop (10 gf, 16 DPA) are indicated. FIGS. 14C-14D show the rhombus shape dimple of Vickers (100 gf, 72 DPA). A crack is observed in the control Al sample but not in the Al/CNTs composite. The depth to dimple length ratio is about 1/30, indicating the depth of indentation is about 1 μm. The dimpled length can be used for hardness calculation (e.g., see FIG. 16) following equation.

HK=14229×P/d² (3)

where P is force in gf, and d is length of long diagonal in μm.

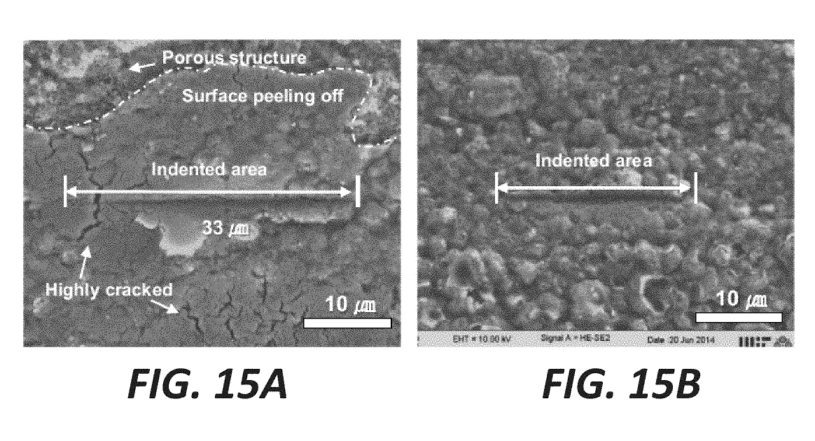

FIGS. 15A-15B show indented area observation in Knoop micro-hardness test on a control Al and an Al/CNTs composite sample, respectively. Since the irradiation damage from the ion accelerator is typically localized beneath the surface within 1 μm depth, the Knoop micro-hardness test can quantify the mechanical behavior in the damaged region. The Knoop micro-hardness test is specially designed for thin film samples. Cracks and porous structure under the surface are observed in the control Al after the Knoop indentation, whereas Al/CNTs composite sample shows almost no cracks, indicating that the Al/CNTs sample has less irradiation embrittlement and swelling.

FIG. 16 shows Knoop hardness, which can be calculated based on the results shown in FIGS. 14A-15B, as a function of DPA. The hardness value further verifies the observation that the Al/CNTs sample has less irradiation embrittlement and swelling. In FIG. 16, the hardness increases up to 328 HK at 3.6 DPA in the control Al. In contrast, the Al/CNTs nano-composite, even starting out having higher hardness by virtue of higher strength, hardens much less in response to radiation, compared to control Al. The initial radiation hardening observed in metallic materials can result from the obstacles to dislocations, such as point-defect clusters, stacking fault tetrahedra and cavities, generated by radiation. Thus, the “1D nano-engineered” Al/CNTs composites have better radiation tolerance (specifically radiation hardening and embrittlement) compared to the reference control Al.

However, once above 3.6 DPA, the Knoop hardness of control Al decreases with increasing helium ion irradiation dose. This phenomenon could be explained by the severe porosity development which reduced the apparent density of materials. The cavity volume fraction in control Al reached 25% at 72 DPA (e.g., see FIG. 10A). The increasing volume of pores cause the transition from hardening to softening, and can result in exceptionally poor toughness as tensile fracture is very sensitive to the size of the largest flaw. In contrast, the cavity volume fraction reached only 4.7% for Al/CNTs composites at 72 DPA, with the largest pore 20 times smaller in volume (e.g., see FIG. 10B). In addition, the maximum value of the hardness in Al/CNTs composite is reached at 16 DPA (5 times larger dose than that in control Al), and the 240 HK peak hardening value is much lower than that of the control Al. Thus the mechanical properties of Al/CNTs composite are more tolerant of both low and high doses of radiation.

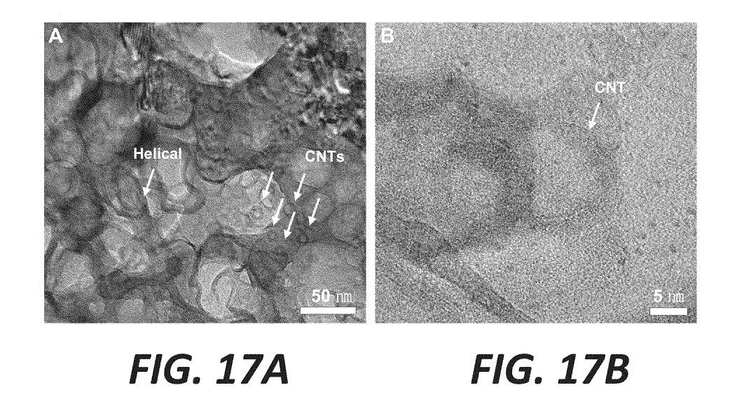

FIGS. 17A-17B show High-resolution TEM (HRTEM) images of post-irradiated Al/CNTs composites. Several tubular cross-sectional structures near each pore can be observed (FIG. 17A). The tubular structure is still retained after 72 DPA He-ion radiation. Some of the tubular walls merge with each other and the helical shapes are also found, as shown in FIG. 1. Thus, the 1D nano-fillers can maintain their general tubular morphology under the He ion irradiation (which generates sparser cascades).

The CNTs in the Al matrix can be further characterized using confocal Raman spectroscopy techniques at 785 nm excitation. In addition, Raman spectroscopy (e.g., Reinshaw, UK) of reference aluminum carbide (Al₄C₃, 98%, 325 mesh, sigma-aldrich) can be measured at 633 nm excitation.

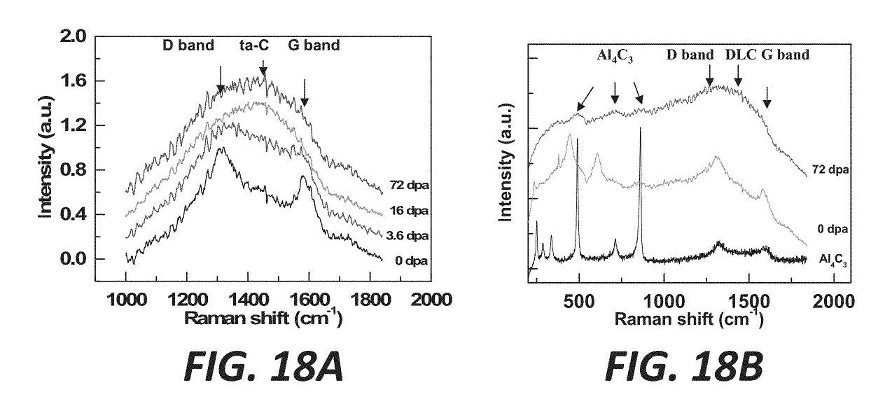

FIG. 18A show confocal Raman microscopy results of Al/CNTs composites after different levels of He ion radiation from 0 DPA to 72 DPA. The Raman spectroscopy indicates quite drastic changes in atomic bonding inside the tubules shown in FIGS. 17A-17B at higher DPA He-ion irradiation, as confirmed from Raman spectra of D and G bands. The strong signal near 1440 cm⁻¹ corresponds to tetrahedral amorphous carbon (ta-C) with highest sp³ content (80-90%).

FIG. 18B show Raman spectrum for comparison of Al₄C₃ and irradiated Al/CNT composites. The spectrum at zero DPA indicate partial aluminum carbide peak near 490, 714 and 860 nm. The small aluminum carbide can be formed during the fabrication process of the Al/CNT composites such as sintering. However, no intensity changes after He ion irradiation whereas G and D band significant shrinks. This phenomenon implies that the carbon from CNTs transforms to diamond-like carbon instead of aluminum carbide.

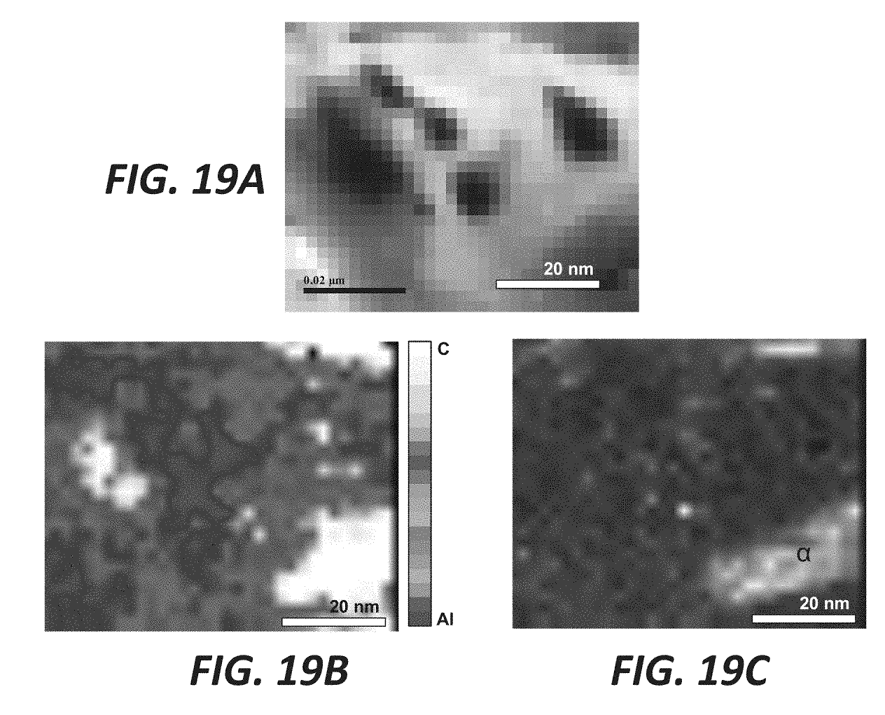

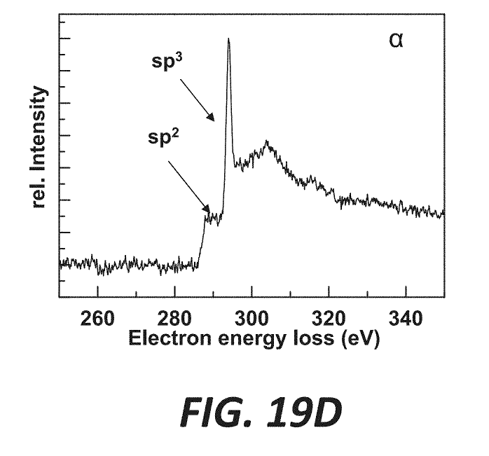

FIG. 19A is STEM high-angle annular dark-field (HAADF) image of an Al/CNTs composite after radiation. The black area is the cavity or very thin area in the cross section sample. FIG. 19B shows temperature mapping of Carbon/Al density ratio. Yellow color indicates higher concentration of carbon. FIG. 19C shows mapping of sp³/sp² ratios of carbon element. FIG. 19D shows the electron energy loss spectroscopy (EELS) spectrum of the carbon in area a shown in FIG. 19C.

The temperature mapping in FIG. 19B shows the region with a high carbon concentration (about 20 nm in width) corresponding to the original diameter of the CNT. The sp³/sp² mapping can be collected from σ* and π* in electron energy loss spectrum (EELS) as shown in FIG. 19D. The fingerprint features of carbon on EELS for sp² bonding (graphite) and sp³ bonding (diamond) is that the σ* peak for sp³ bonding is enhanced significantly while π* peak is reduced significantly, in contrary to that for sp² bonding. Quantitatively, the ratio of the integral of an energy box (about 2 eV) around σ* peak to that of π* peak can be employed to determine the sp³/sp² bonding mapping for carbon elements.

The sp³/sp² mapping results (FIGS. 19C-19D) indicate strong sp³ signal at the region of high carbon concentration. The observations suggest that the carbon tubular nanostructures observed in TEM are composed of diamond-like carbon with tetrahedral amorphous sp³ bonding, instead of aluminum carbide (Al₄C₃) which should form according to the equilibrium phase diagram below 2160° C.

In reference to pure Al and graphite, the Gibbs free energy of formation for the stable phase of Al₄C₃ (rhombohedral) is about −194.4 kJ/mol at room temperature or −2.01 eV per Al₄C₃ unit formula. On a per carbon basis, it is not as high as that for ZrC (−2.14 eV per ZrC), but is comparable to SiC (−0.76 eV per SiC) and much higher than cementite (−0.18 eV per Fe₃C). So the fact that much of the carbon nanostructures survive without forming the carbide after 72 DPA He-ion irradiation is unexpected and surprising. On the other hand, the conversion of sp² bonding of carbon in CNTs to sp³ of ta-C agrees with the previous understanding of radiation damage of carbon.

To further study the compositions of the Al/CNTs composites after radiation, Vienna Ab-initio Simulation Package (VASP) can be employed to compute the structure of Al₄C₃. Calculations can be carried out using generalized gradient approximation (GGA) in the PBE form for the exchange-correlation functional. To ensure convergence, 520 eV plane wave cutoff and 20×20×20 Monkhorst-Pack grid can be adopted. Calculation parameters are summarized in Table 3 below.

TABLE 3
Calculation parameters in VASP

| Al₄C₃ | Stable | Our nanorod |
|---|---|---|
| Kinetic energy cutoff [eV] | 520 | 520 |
| Run type | GGA-PBE | GGA-PBE |
| K points | Monkhorst-Pack | Monkhorst-Pack |
| | 20 × 20 × 20 | 20 × 20 × 20 |
| Precision | High | High |
| Eₜₒₜ [eV] | −43.3295 | −40.462108 |
| Fermi energy [eV] | 7.29466942 | 8.75479555 |
| K-S gap [eV] | 1.42 | 0.00 |

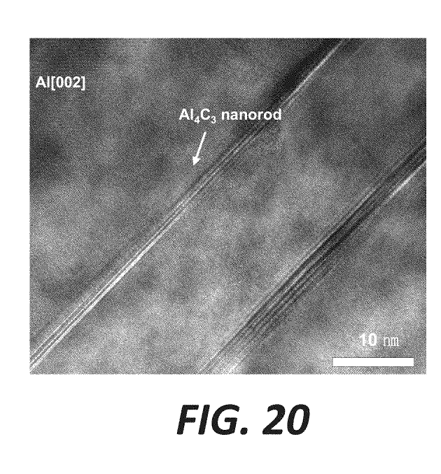

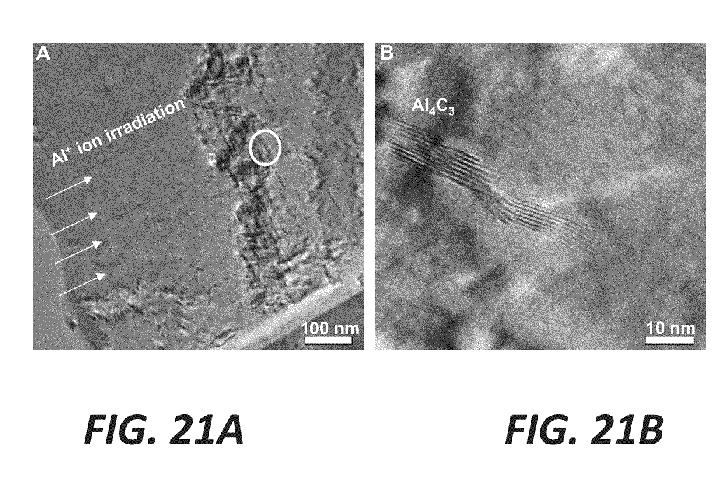

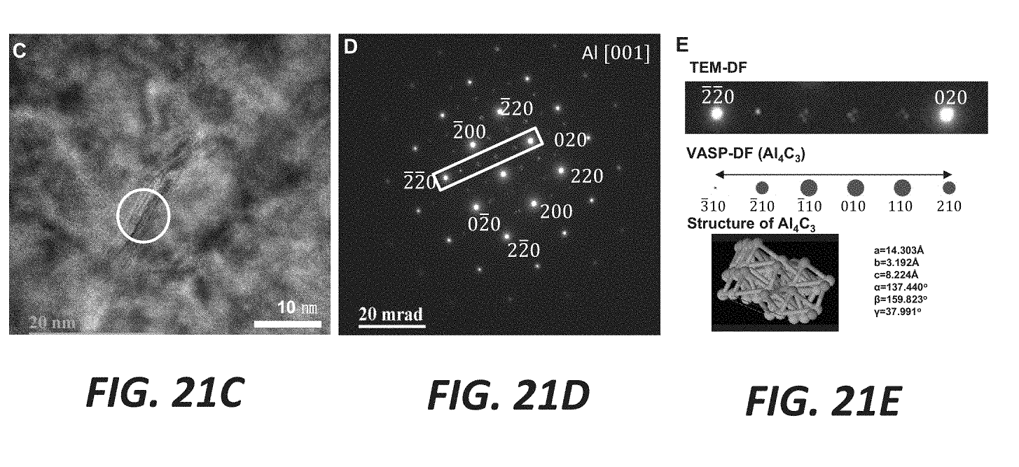

FIG. 20 shows Al₄C₃ nano-carbide formed under 72 DPA Al self-ion irradiation of Al/CNTs composites. FIGS. 21A-21E illustrate microstructure change after aluminium self-ion irradiation. FIG. 21A shows the irradiation direction (indicated by white arrow) and the generation of 1D Al₄C₃ nanorod. FIG. 21B shows the enlargement of white circle area of Al₄C₃ show in FIG. 21A. FIG. 21C shows the lattice structure of a TEM image of Al₄C₃. FIG. 21D shows diffraction pattern [001] and FIG. 21E shows the confirmation of the Al₄C₃ in Al matrix through VASP simulation. The 5-fold division of Al, from (020) to (2̅2̅0), matches the distance of Al₄C₃ from (3̅10) to (210).

Aluminum self-ion irradiation with higher energy of 2 MeV (20× that of helium ion) which creates denser cascades can eventually disintegrate the pure carbon nanostructure and generate slender Al₄C₃ nanocarbides, as seen in FIG. 20 and FIGS. 21A-21B (also in descriptions with reference to FIG. 1). The denser cascade can provide higher probability to mix carbon with the matrix aluminum atoms. The 1D nature of Al₄C₃ nanocarbides is confirmed in a series of tilting images inside the TEM. The electron diffraction along Al [001] zone axis on the nanocarbide shows that the new structure embedded in the matrix is not the rhombohedral phase of Al₄C₃ (ICSD number 14397), but a metastable triclinic phase (e.g., see materialsproject.org mp632442). Density functional theory calculations reveal that this metastable Al₄C₃ nanocarbide has a higher formation energy of about 2.8 eV per unit formula above the rhombohedral phase ground state. This energetic metastability is about 1.877 MJ/kg, almost half of the detonation energy density of TNT.

Many distinct lattice orientation relationships are also present between the newly formed Al₄C₃ and Al matrix, with semi-coherent and incoherent interfaces based on high-resolution TEM observations. The 1D nanocarbides can likely benefit energetically from the interfacial energy considerations with the matrix, which otherwise would be considered high energy in bulk form.

FIG. 20 is quite remarkable in that it shows two Al₄C₃ nanocarbides running parallel to each other, separated by about 20 nm, on the order of D of the original CNTs used in making the Al/CNTs composites. These two nanocarbides can be decomposition products from the same CNTs, which originally ran in the same direction. The high-energy self-ion radiation may have destroyed the hollowness of the CNTs and backfilled the CNTs with Al. But vestiges of the original 1D nanostructures remain like fossil record that can preserve the slender morphology of the CNTs. The nanocarbides are thus templated by the original carbon nanostructures, and this in situ formation could be a nano-composite paradigm for creating radiation-tolerant nanodispersion-strengthened metals.

In the jewelry market, the use of 24 k gold can be limited because it is soft and easily worn by scratches. In contrast, Au/carbon composites described herein can add mechanical stability and wear resistance to the gold with minimum cost increase. The Au/carbon composite can enable the use of 24 k gold as jewelry materials adding more degree of freedom to the design. The improved mechanical property and the wear resistance of the Au/carbon composite are also useful for electric connections improving the lifetime of the products.

In the Au/carbon composite, carbon nanostructures is introduced into the gold grain, forming two phase composite structure, which can have special advantage to improve significant mechanical properties such as the prevention of the dislocation propagation. Strong sp² carbon-carbon bonding can resist the dislocation movement and enhance the mechanical properties. Furthermore, the carbon nanostructure inside grain can prevent the crack propagation, resulting in improvement of the toughness.

Carbon is very light density compared to other metals such as Cu, Ag, Fe, Ni, Pb which are used to enhance the mechanical properties of the pure gold. Therefore, less than 0.5% of carbon can enhance the hardness level of 18 k gold to a noticeable extent.

The Au/carbon composite can be fabricated using methods similar to the methods 300 shown in FIG. 3. More specifically, CNTs (or other carbon nanostructures such as graphene and nanoparticles) are dispersed in the gold matrix by sonication of the gold powder and CNTs followed by ball milling. The mixture can be then pressed.

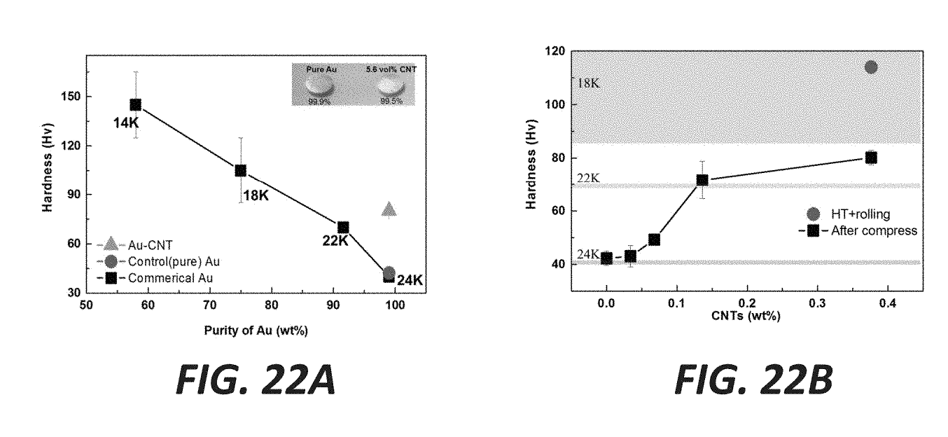

FIG. 22A shows the Vickers hardness test results for gold/CNT composite in comparison with commercial gold with different purities. 24 k gold is known to be very soft. However, with 5.6 vol % of CNT added, the hardness exceeds that of 22 k and reaches as high as 18 k gold.

FIG. 22B shows the Vickers hardness test with different CNT content and additional process. Simple heat treatment and rolling can increase the hardness even higher than that 18 k gold. In other words, 24 k gold can be tuned to have similar mechanical properties of 18 k gold.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all methods, dimensions, materials, and configurations described herein are meant to be exemplary and that the actual methods, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, article, material, and/or method described herein. In addition, any combination of two or more such features, systems, articles, materials, kits, and/or methods, if such features, systems, articles, materials, and/or methods are not mutually inconsistent, is included within the inventive scope of the present disclosure.

Also, various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
obtaining carbon nanotubes (CNTs);
atomically welding the CNTs with metal particles to create CNT-embedded metal particles;
consolidating the CNT-embedded metal particles; and
forming the consolidated metal/CNTs.

2. The method of claim 1, wherein the consolidating includes spark plasma sintering.

3. The method of claim 1, wherein the consolidating includes forming metal-CNT covalent bonds.

4. The method of claim 1, wherein obtaining the CNTs includes declustering CNTs on surfaces of metal particles.

5. The method of claim 1, further comprising:
coating the CNTs prior to atomic welding.

6. The method of claim 1, further comprising:
coating the CNTs prior to atomic welding, wherein the coating is a polar covalent coating.

7. The method of claim 6, wherein the coating is at least one of a silicon compound, oxygen compound, boron compound, nitrogen compound, and/or carbon compound.

8. The method of claim 1, further comprising:
coating the CNTs prior to atomic welding, wherein the coating is a carbide coating.

9. The method of claim 1, further comprising:
coating the CNTs prior to atomic welding, wherein the coating is silicon carbide.

10. The method of claim 1, further comprising:
coating the CNTs prior to atomic welding, wherein coating the CNTs prior to atomic welding includes ball milling.

11. The method of claim 1, further comprising:
coating the CNTs prior to atomic welding, wherein coating the CNTs prior to atomic welding includes induction heating of the CNTs with a coating mixture.

12. The method of claim 11, wherein the coating mixture is elemental carbon and elemental silicon, wherein the induction heating of the CNTs causes the elemental silicon and elemental carbon to form a silicon carbide coating on the CNTs.

13. The method of claim 1, wherein the atomic welding is under an inert atmosphere.

14. The method of claim 1, wherein the metal particles comprise aluminum powder.

15. The method of claim 1, wherein the metal particles comprise gold powder.

16. The method of claim 1, wherein the metal particles comprise magnesium powder.

17. The method of claim 1, wherein the metal particles comprise zirconium powder.

18. The method of claim 1, wherein the metal particles comprise copper powder.

19. The method of claim 1, wherein the metal particles comprise iron powder.

20. The method of claim 1, wherein there is no grain boundary flocculation in the formed metal/CNTs.

21. The method of claim 1, wherein the CNTs are uniformly dispersed in the formed metal/CNTs.

22. The method of claim 1, wherein the CNTs are multiwall CNTs.

23. The method of claim 1, wherein a strength of the formed metal/CNTs is higher than a strength of the metal alone.

24. The method of claim 23, wherein a radiation hardening of the formed metal/CNTs is lower than a radiation hardening of the metal alone.

25. The method of claim 23, wherein an irradiation embrittlement of the formed metal/CNTs is less than an irradiation embrittlement of the metal alone.

26. A material, comprising:
a nanostructure-metal matrix composite, the nanostructure-metal matrix composite including:
a metal; and
at least one nanofiller component dispersed in the grains of the metal.

27. The material of claim 26, wherein there is no grain boundary flocculation caused by the at least one nanofiller component.

28. The material of claim 26, wherein the at least one nanofiller component comprises carbon nanotubes (CNTs).

29. The material of claim 26, wherein the at least one nanofiller component comprises multiwalled carbon nanotubes (MWCNTs).

30. The material of claim 26, wherein the at least one nanofiller component comprises graphene.

31. The material of claim 26, wherein the at least one nanofiller component comprises flexible nanostructures having an aspect ratio greater than 100.

32. The material of claim 26, wherein the at least one nanofiller component comprises flexible nanostructures having an aspect ratio greater than 1000.

33. The material of claim 26, wherein the metal comprises aluminum.

34. The material of claim 26, wherein the metal comprises gold.

35. The material of claim 26, wherein the metal comprises magnesium.

36. The material of claim 26, wherein the metal comprises zirconium.

37. The material of claim 26, wherein the metal is copper.
